(19) United States
(12) Patent Application Publication
(10) Pub. No.: US 2011/0135365 A1
(43) Pub. Date: Jun. 9, 2011

(54) IMAGE FORMING APPARATUS AND MEDIUM OUTPUT METHOD THEREFOR

(75) Inventors: Seung-soo OAK, Seongnam-si (KR); Ho-sung Han, Suwon-si (KR)

(73) Assignee: SAMSUNG ELECTRONICS CO., LTD., Suwon-si (KR)

(21) Appl. No.: 12/822,481

(22) Filed: Jun. 24, 2010

(30) Foreign Application Priority Data
Dec. 9, 2009 (KR) 10-2009-0121594

(51) Int. Cl. G03G 15/00

(52) U.S. Cl. 399/407

(57) ABSTRACT

An image forming apparatus and the method thereof are provided. An image forming apparatus including: a main body configured to have an image forming unit which forms an image on a printing medium; an after-treatment unit connected to the main body, the after-treatment unit being configured to perform a predetermined after-treatment on a printing medium outputted from the main body; at least one main body output tray coupled to the main body; and a controller configured to detect whether or not the after-treatment unit is in a possible state to perform the after-treatment on the printing medium when the printing medium is predetermined to be outputted from the main body to the after-treatment unit, and to selectively output the printing medium to one of the after-treatment unit and the main body output tray according to the detected result.

### CROSS-REFERENCE TO RELATED APPLICATIONS

This application claims priority from Korean Patent Application No. 10-2009-0121594, filed on Dec. 9, 2009 in the Korean Intellectual Property Office, the disclosure of which is incorporated herein by reference.

### BACKGROUND

1. Field

Apparatuses and methods consistent with the exemplary embodiments relate to an image forming apparatus which forms an image on a printing medium and a medium output method therefore, and more particularly, to an image forming apparatus having a main body equipped with an after-treatment unit and a medium output method therefore, capable of improving a configuration for outputting printing media.

2. Description of the Related Art

An image forming apparatus, which is an apparatus for forming a visual image by a developing solution or an ink on a printing medium, is typically embodied as a printer, a copier, a multi-function printer or the like. The image forming apparatus includes a main body having a built-in image forming unit which forms an image on a printing medium. The printing medium on which the image has been formed is outputted to an outer side of the main body.

Since such a main body of the image forming apparatus mainly forms an image on the printing medium, the image forming apparatus can further include an after-treatment unit which is connected to the main body to perform various after-treatments on the printing medium. The after-treatment unit performs non-limited after-treatments on printing media which images have been formed on and, then, have been outputted from the main body. For example, a plurality of printing media may be bound into a book by the after-treatment unit. As such, the after-treatment unit can expand the function of the image forming apparatus by performing such after-treatment functions that are not able to be performed by the image forming apparatus.

However, when a conventional after-treatment unit is not in a possible state to perform such after-treatments on the printing media due to various reasons, it may become difficult for the image forming apparatus having the conventional after-treatment unit to output printing media. In other words, when the conventional after-treatment unit is broken down due to various reasons, the printing media on which images have been formed may not be outputted from the main body.

### SUMMARY

Accordingly, one or more exemplary embodiments provide an image forming apparatus and a medium output method therefore, capable of outputting a printing medium to an outside when an after-treatment unit is in an impossible state (or not able) to perform an after-treatment on the printing medium.

The foregoing and/or other aspects may be achieved by providing an image forming apparatus including: a main body configured to have an image forming unit which forms an image on a printing medium; an after-treatment unit connected to the main body, the after-treatment unit being configured to perform a predetermined after-treatment on a printing medium outputted from the main body; at least one main body output tray coupled to the main body; and a controller configured to detect whether the after-treatment unit is in a possible state to perform the after-treatment on the printing medium when the printing medium is predetermined to be outputted from the main body to the after-treatment unit, and to selectively output the printing medium to one of the after-treatment unit and the main body output tray according to the detected result.

The controller may output the printing medium to the after-treatment unit, if the after-treatment unit is in the possible state, or to the main body output tray, if the after-treatment unit is not in the possible state.

The after-treatment unit may include at least one after-treatment module configured to perform the after-treatment on the printing medium outputted from the main body; and a detecting module configured to detect whether the after-treatment module is able to perform the after-treatment on the printing medium to transfer a detected result to the controller.

The after-treatment unit may include an after-treatment unit output tray configured to load therein the printing medium subjected to the after-treatment and outputted by the after-treatment module, wherein the detecting module may detect whether a jam of the printing medium is generated between the main body and the after-treatment unit output tray.

The after-treatment unit may include at least one of a stapling module configured to staple the printing media; a punching module configured to punch holes on the printing media; and a folding module configured to fold the printing media.

The apparatus may include a display unit installed in the main body, wherein, if the after-treatment unit is not in the possible state, the controller may control the display unit to display an error message reporting that the after-treatment unit is not in the possible state.

The apparatus may include a user input unit installed in the main body, wherein, when the error message is displayed by the display unit, if a first command is inputted through the user input unit, the controller may output the printing medium from the main body to the main body output tray according to the first command, the first command being preset to output the printing medium from the main body.

The apparatus may include a user input unit installed in the main body, wherein, when the error message is displayed by the display unit, if a second command is inputted through the user input unit, the controller may control the image forming unit not to form an image, the second command being preset to cancel a formation of an image.

The apparatus may include a guide unit installed in the main body, the guide unit being configured to selectively transfer the printing medium to the after-treatment unit or the main body output tray, wherein the controller may control an operation of the guide unit according to whether the after-treatment unit is in the possible state.

Another aspect of the present invention may be achieved by providing a method of outputting a printing medium on which an image has been formed, in an image forming apparatus, the method including: forming an image on a printing medium; detecting whether the after-treatment unit is in a possible state where it is possible to perform the after-treatment on the printing medium when the printing medium is predetermined to be outputted from a main body of the apparatus to a after-treatment unit which performs a predetermined after-treatment on the printing medium; and outputting selectively the printing medium to one of the after-treatment unit and at least one main body output tray, coupled to the main body, according to a detected result.

The selectively outputting of the printing medium may include: outputting the printing medium to the after-treatment unit if the after-treatment unit is in the possible state, or to the main body output tray, if the after-treatment unit is not in the possible state.

The detecting of whether or not the after-treatment unit is in the possible state may include detecting whether a jam of the printing medium is generated in the after-treatment unit.

The detecting of whether or not the after-treatment unit is in the possible state may include displaying an error message reporting that the after-treatment unit is not in the possible state, if the after-treatment unit is not in the possible state.

The selectively outputting of the printing medium may include outputting the printing medium to the main body output tray according to a first command, if the first command is inputted through the user input unit while the error message being displayed, the first command being preset to output the printing medium from the image forming apparatus.

The selectively outputting of the printing medium may include canceling the forming of an image according to a second command, if the second command is inputted through the user input unit while the error message being displayed, the second command being preset to cancel a formation of an image.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 shows an example of an image forming apparatus in accordance with an exemplary embodiment;

FIG. 2 is a block diagram showing a control structure of the image forming apparatus shown in FIG. 1;

FIG. 3 is a control flowchart showing a method of controlling the image forming apparatus shown in FIG. 1; and

FIG. 4 is a control flowchart showing a method of controlling an image forming apparatus in accordance with an other exemplary embodiment.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout. Throughout the description of the first embodiments, only elements directly relative to the spirit and scope of the exemplary embodiments are described, while the description of other elements may be omitted. This, however, does not mean that the omitted elements are not essential to embody an image forming apparatus 1 of the exemplary embodiments.

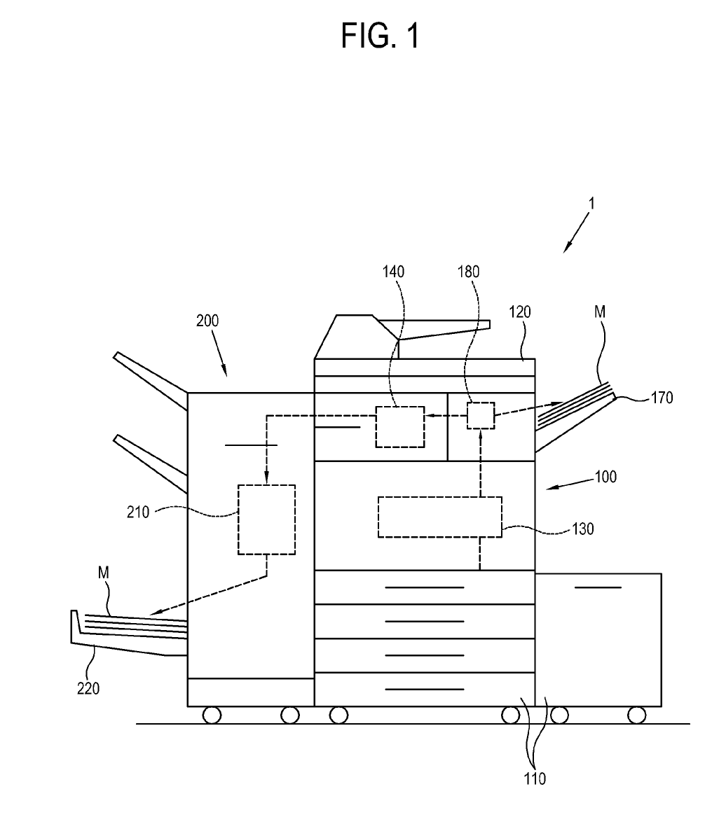

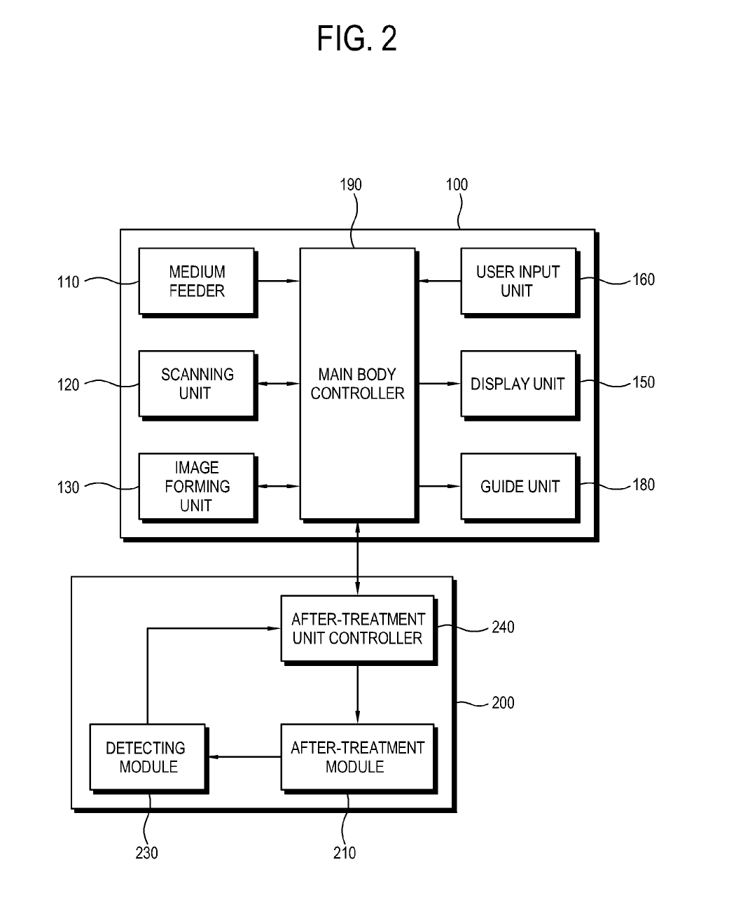

FIG. 1 shows an example of the image forming apparatus 1 in accordance with an exemplary embodiment, and FIG. 2 is a block diagram showing a control structure of the image forming apparatus 1. As shown in FIG. 1, a feeding path and various components arranged in the feeding path are shown by dotted lines inside the image forming apparatus 1, the feeding path through which printing-target media M are fed.

As shown in FIGS. 1 and 2, the image forming apparatus 1 of the exemplary embodiments is embodied as a copier; however, the spirit and scope of these exemplary embodiments are applicable to a printer, a multi-function printer (MFP) and the like.

The image forming apparatus 1 may include a main body 100 and an after-treatment unit 200 which performs various predetermined after-treatments on printing media M outputted from the main body 100. The after-treatment unit, which is referred to as “finisher,” may be connected to a side surface of the main body 100.

The main body 100 may include a medium feeder 110 which feeds a printing medium M; a scanning unit 120 which scans a predetermined object; an image forming unit 130 which forms an image on the printing medium M fed from medium feeder 110; a bridge unit 140 which transfers the printing medium M on which the image has been formed to the after-treatment unit 200; a display unit 150 which displays an operation state of the main body 100; and a user input unit 160 which is manipulated by a user.

The main body 100 may further include a main body output tray 170 which is coupled to an outer side of the main body 100; a guide unit 180 which guides the printing media M to one of the bridge unit 140 and the main body output tray 170; and a main body controller 190 which controls the operation of the guide unit 180.

In the aforementioned configuration of the embodiment, when the printing media M are predetermined to be outputted to the after-treatment unit 200, the printing media M may be outputted to one of the after-treatment unit 200 and the main body tray 170 according to whether or not the after-treatments unit 200 is in a possible (or functionally operable) state to perform the after-treatments on the printing media M. More specifically, if the after-treatment unit 200 is not able to perform the after-treatments on the printing media on which images are formed by the image forming unit 130, the printing media M may be outputted to the main body output tray 170 (that is, another media destination). Accordingly, even when the after-treatment unit 200 is not able to perform the after-treatments on the after-treatment unit 200, it is possible to output the printed-media M.

In the meantime, the after-treatment unit 200 may include at least one after-treatment module 210 which performs corresponding after-treatments on the printing media M; an after-treatment unit output tray 220 which loads therein the printing media M subjected to the after-treatments and outputted by the after-treatment module 210; a detecting module 230 which detects whether or not the after-treatment unit 200 is able to perform the after-treatments on the printing media M; and an after-treatment unit controller 240 which transfers a detected result of the detecting module 230 to the main body controller 190.

Hereinafter, various components of the main body 100 will be described.

The medium feeder 110 may load therein a plurality of printing-target media M and, if a printing operation is started, feeds the loaded printing-target media M one by one to the image forming unit 130. Moreover, the medium feeder 110 may load different-sized printing-target media Mat a plurality of different sections therein; and feeds to the image forming unit 130 each of the different-sized printing-target media M located at the different sections selected according to the control of the main body controller 190. The medium feeder 110 may be installed inside the main body 100 or embodied as an option box which is coupled to an outer side of the main body 100 to feed the printing-target media M thereto.

The scanning unit 120 may scan a specific object to form a scanned image corresponding to the specific object. The scanning unit 120 may be embodied in a hybrid type to scan a fixed object or an object that is being fed. The scanning unit 120 may transfer the scanned image to the main body controller 190. Then, a visual image corresponding to the scanned image may be formed on the printing medium M by the image forming unit 130, or the scanned image itself may be transferred to an host apparatus which is connected to the image forming apparatus 1 directly or by a network.

The image forming unit 130 may form a visual image by a developing solution or an ink on the printing medium M fed from the medium feeder 110. The image forming unit 130 may form the visual image based on a scanned image transferred from the scanning unit 120 or image data transferred from an external host apparatus (not shown).

The bridge unit 140 may output the printing media M on which images have been formed by the image forming unit 130 to the after-treatment unit 120 connected to the main body 100. The bridge unit 140 may be configured, by employing a roller, a conveyer and/or the like, to guide the printing media M to the after-treatment unit 200. The bridge unit 140 may be installed at a position where the printing media M are outputted and loaded, if the after-treatment unit 120 is separated from the main body 100.

The display unit 150 may be embodied as a liquid crystal panel installed at an outer side of the main body 100. The display unit 150 may display various event messages related to the operation states of the image forming apparatus 1 according to the control of the main body controller 190 or corresponding setting information when a user sets up the image forming apparatus 1 by manipulating the user input unit 160.

The user input unit 160 may be installed close to the display unit 150 located at the outer side of the main body 100. The user input unit 160 may transfer to the main body controller 190 a predetermined command inputted by a user's manipulation. The user input unit 160 may be configured by employing mechanical or electric keys or embodied as a single unit with a touch screen serving as the display unit 150. Alternatively, the user input unit 160 may be embodied as a remote control (not shown) which is separated from the main body 100, instead of being installed therein. Further alternatively, a host apparatus (not shown) may serve as the user input unit 160 by being connected and communicating with the main body 100.

The main body output tray 170 may be coupled to the main body 100 such that the printing media M are outputted from the main body 100 and loaded in the main body output tray 170, the printing media M on which images have been formed by the image forming unit 130. At least one main body output tray 170 may be coupled to the main body 100. In the embodiment, it is merely an example that one main body output tray 170 may be coupled to the main body 100.

The guide unit 180 may be installed at a branch portion at which a transfer path through the printing media M are outputted from the image forming unit 130 is branched into a path to the bridge unit 140 and another path to the main body output tray 170. Accordingly, the guide unit 180 may be operated according to the control of the main body controller 190 such that the printing media M are selectively transferred to the after-treatment unit 200 or the main body output tray 170. As for a plurality of main body output trays 170, the guide unit 180 may guide the printing media M to one of the main body output trays 170 selected according to the control of the main body controller 190.

Such a configuration of the guide unit 180 is not limited thereto. Alternatively, the guide unit 180 may be configured to be pivoted in a predetermined range, so that the transfer path of the printing media M is selectively connected to the path to the bridge unit 140 or the main body output tray 170 according to the pivoting range. Further alternatively, the guide unit 180 may be configured to be moved between a first position and a second position, so that the transfer path of the printing media M is selectively connected thereto according to whether the guide unit 180 is moved to the first or the second position. Such an operation of the guide unit 180 may be controlled by the main body controller 190.

The main body controller 190 may receive a scanned image outputted from the scanning unit 120 or image data supplied from a host apparatus (not shown) to start the printing operation based on the received scanned image or image data. The main body controller 190 may control the medium feeder 110 to feed the printing-target media M to the image forming unit 130 one by one and the image forming unit 130 to form a visual image corresponding to the image data on the fed printing medium M one by one.

The main body controller 190 may output the printing medium M to a predetermined output unit in the image forming apparatus 1, the printing medium on which an image has been formed. The predetermined output unit may be embodied as the after-treatment unit 200 or the main body output tray 170. The printing media M may be outputted to one of such output units according to a default or a setting of the user input unit 160.

When the printing media M are predetermined to be transferred to the after-treatment unit 200 to be subjected to the after-treatments, the main body controller 190 may transfer to the bridge unit 140 the printing media M on which images have been formed such that the printing media M are transferred to the after-treatment unit 200 through the bridge unit 140.

Hereinafter, various components of the after-treatment unit 200 will be described.

At least one after-treatment module 210 may be arranged in a transfer path inside the after-treatment unit 210, the transfer path through which the printing media M are transferred. The after-treatment module 210 may perform at least one after-treatment on the printing media M outputted from the main body 100. The after-treatment module 210 may be configured in various ways according to a model, a type and/or the like of the after-treatment unit 200. Accordingly, such a design configuration thereof is not limited thereto.

For example, the after-treatment module 210 may include at least one of a stapling module which staples the printing media M; a punching module which punches holes on the printing media M to bind them; a folding module which folds the printing media M; and a booklet module which makes the printing media M as a book.

The after-treatment output tray 220 may be coupled to an outer side of the after-treatment unit 200 to load therein the printing media M subjected to the after-treatments and outputted by the after-treatment module 210.

The detecting module 230 may detect whether or not the after-treatment unit 200 is able to perform the after-treatments on the printing media M to transfer a detected result to the after-treatment unit controller 240.

The detecting module 230 may detect various states of the after-treatment unit 200. For example, when there is no residual staples used for the stapling module to staple the printing media M; when a jam of the printing media M is generated between the main body 100 and the after-treatment unit output tray 220 in the after-treatment unit 200; or when the after-treatment unit 200 is not operable, the detecting module 230 may detect such states and determine that the after-treatment unit 200 is not in a possible (or functionally operable) state to perform the after-treatments on the printing media M.

The after-treatment unit controller 240 may make a two-way communication with the main body controller 190 to control the operation of the after-treatment module 210 based on information received therefrom. Further, the after-treatment unit controller 240 may transfer the detected result of the detecting module 230 to the main body controller 190.

In the image forming apparatus 1 including the main body 100 and the after-treatment unit having the aforementioned configurations, when a printing operation is started, the image forming unit 130 may form an image on a printing medium M fed from the medium feeder 110. If printing media M are predetermined to be outputted to the after-treatment unit 200, the main body controller 190 may receive from the after-treatment unit controller 240 information related to whether the after-treatment unit 200 is in a possible state to perform after-treatments on the printing media M.

The after-treatment unit controller 240 may transfer to the main body controller 190 state information related to the after-treatment unit 200 based on the detected result received from the detecting module 230 in a real time or in a predetermined cycle.

If the after-treatment unit 200 is in the possible state, the main body controller 190 may control the guide unit 180 to guide the printing media M to the bridge unit 140, the printing media M on which images have been formed, so that the guided printing media M are subjected to the after-treatments.

On the other hand, if the after-treatment unit 200 is not in the possible state, the main body controller 190 may control the guide unit 180 such that the printing media M are outputted to the main body output tray 170.

In accordance with such a configuration of the embodiment, when the printing media M are predetermined to be outputted to the after-treatment unit 200, it is possible to selectively output the printing media M to the after-treatment unit 200 or the main body output tray 170 according to whether the after-treatment unit 200 is in the possible state. Accordingly, even when the after-treatment unit 200 is not able to perform the after-treatments on the printing media M, the printing media M can be outputted from the main body 100.

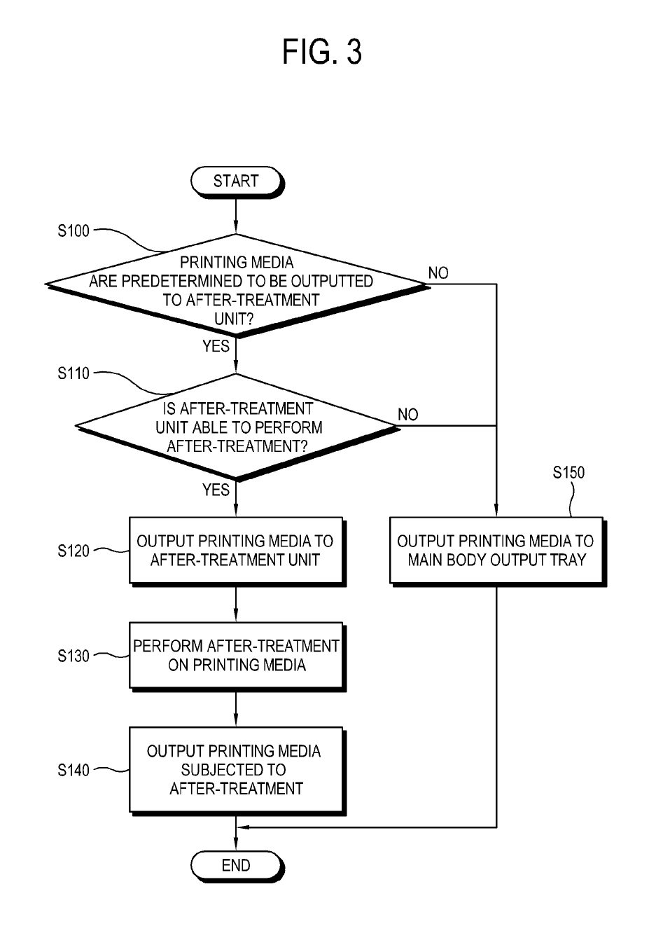

Hereinafter, a method of controlling the image forming apparatus 1 in accordance with the embodiment will be described with reference to FIG. 3. FIG. 3 is a control flowchart showing such a control method.

As shown in FIG. 3, when a printing operation is started, the main body controller 190 may check whether the printing media M are predetermined to be outputted to the after-treatment unit 200 (S100).

If the printing media M are predetermined to be outputted to the after-treatment unit 200, the main body controller 190 may check whether the after-treatment unit 200 is in a possible state to perform the after-treatments on the printing media M (S110).

If the after-treatment unit 200 is in the possible state, the main body controller 190 may output to the after-treatment unit 200 the printing media M on which images have been formed by the image forming unit 130 (S120). Thereafter, the after-treatment unit 200 may perform the after-treatments on the printing media M and, then, the printing media M subjected to the after-treatments may be outputted from the after-treatment unit 200 (S140).

On the other hand, if it is determined in the process S110 that the after-treatment unit 200 is not in the possible state, the main body controller 190 may output the printing media M to the main body output tray 170 instead of the after-treatment unit 200, the printing media M on which images have been formed (S150). Meanwhile, if it is checked in the process S100 that the printing media M is not predetermined to be outputted to the after-treatment unit 200, the printing media M may be outputted to the main body output tray 170 (S150).

In this way, in accordance with the embodiment, when the printing media M are predetermined to be outputted to the after-treatment unit 200 and it is checked that the after-treatment unit 200 is not able to perform the after-treatment on the printing media M, the printing media M may be outputted to an additional member, e.g., the main body output tray 170. Accordingly, even when the after-treatment unit 200 is broken down, the printing media M can be outputted from the main body 100.

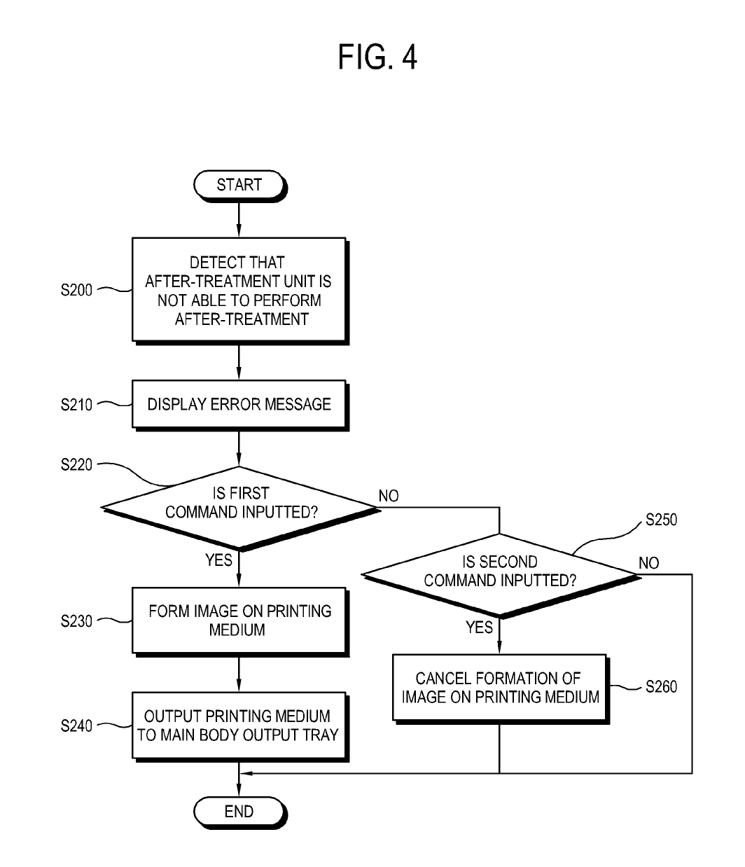

In the meantime, although the selective output of the printing media M to the after-treatment unit 220 or the main body output tray 170 is automatically carried out in the embodiment, the spirit and scope of this disclosure is not limited to the first embodiment. For that reason, a configuration of another exemplary embodiment where such selective output thereof is carried out by a user's input will be described below with reference to FIG. 4. FIG. 4 is a flow chart showing such a process of the another embodiment.

As shown in FIG. 4, in accordance with the another embodiment, the printing media M are predetermined to be outputted to the after-treatment unit 200 as an initial state.

As shown in FIG. 4, the main body controller 190 may detect that the after-treatment unit 200 is not in a possible state where it is possible to perform the after-treatments on the printing media M (S200). Then, the main body controller 190 may control the display unit 150 to display an error message reporting that the after-treatment unit 200 is not in the possible state (S210).

Then, the main body controller 190 may check whether a first predetermined command or a second predetermined command is inputted through the user input unit 160 (S220 and S250).

If the main body controller 190 receives the first predetermined command (S220), the main body controller 190 may allow an image to be formed on a printing medium M and the printing medium M to be outputted to the main body output tray 170, the printing medium M on which the image has been formed (S240).

On the other hand, if the main body controller 190 receives the second predetermined command (S250), the main body controller 190 may cancel the formation of an image on a printing medium M (s260). Here, if images are to be formed on a plurality of printing-target media M, the formations of all the images on the printing-target media M may be canceled.

In this ways, in accordance with the another embodiment, the image forming apparatus 1 may display an error message if the after-treatment unit 200 is not in the possible state to perform the after-treatments on the printing media M. Then, a user may manipulate the user input unit 160 to control the output of the printing media M.

In accordance with the exemplary embodiments, when printing media are predetermined to be outputted to an after-treatment unit, even though the after-treatment unit is not able to perform an after-treatment on the printing media due to a breakdown for example, it is possible to output the printing media by allowing the printing media to be outputted to an additional unit, e.g., an output tray, which is installed in a main body.

Further, when the printing media are outputted to the output tray, a user's convenience can be improved by allowing the printing media to be automatically outputted; or displaying an error message and allowing the printing media to be outputted according to a user's input.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An image forming apparatus, comprising:
a main body configured to have an image forming unit which forms an image on a printing medium;
an after-treatment unit connected to the main body, the after-treatment unit being configured to perform a predetermined after-treatment on a printing medium outputted from the main body;
at least one main body output tray coupled to the main body; and
a controller configured to detect whether the after-treatment unit is in a possible state to perform the after-treatment on the printing medium when the printing medium is predetermined to be outputted from the main body to the after-treatment unit, and to selectively output the printing medium to one of the after-treatment unit and the main body output tray according to the detected result.

2. The apparatus of claim 1, wherein the controller outputs the printing medium to the after-treatment unit, if the after-treatment unit is in the possible state, or to the main body output tray, if the after-treatment unit is not in the possible state.

3. The apparatus of claim 1, wherein the after-treatment unit comprises at least one after-treatment module configured to perform the after-treatment on the printing medium outputted from the main body;
a detecting module configured to detect whether the after-treatment module is able to perform the after-treatment on the printing medium to transfer a detected result to the controller; and
an after-treatment unit controller to communicate with the main body to control operations of the after-treatment module.

4. The apparatus of claim 3, wherein the after-treatment unit further comprises an after-treatment unit output tray configured to load therein the printing medium subjected to the after-treatment and outputted by the after-treatment module,
wherein the detecting module detects whether a jam of the printing medium is generated between the main body and the after-treatment unit output tray.

5. The apparatus of claim 3, wherein the after-treatment unit comprises at least one of a stapling module configured to staple the printing media; a punching module configured to punch holes on the printing media; a folding module configured to fold the printing media, or combinations thereof.

6. The apparatus of claim 1, further comprising a display unit installed in the main body,
wherein, if the after-treatment unit is not in the possible state, the controller controls the display unit to display an error message reporting that the after-treatment unit is not in the possible state.

7. The apparatus of claim 6, further comprising a user input unit installed in the main body,
wherein, when the error message is displayed by the display unit, if a first command is inputted through the user input unit, the controller outputs the printing medium from the main body to the main body output tray according to the first command, the first command being preset to output the printing medium from the main body.

8. The apparatus of claim 6, further comprising a user input unit installed in the main body,
wherein, when the error message is displayed by the display unit, if a second command is inputted through the user input unit, the controller controls the image forming unit not to form an image, the second command being preset to cancel a formation of an image.

9. The apparatus of claim 1, further comprising a guide unit installed in the main body, the guide unit being configured to selectively transfer the printing medium to the after-treatment unit or the main body output tray,
wherein the controller controls an operation of the guide unit according to whether or not the after-treatment unit is in the possible state.

10. A method of outputting a printing medium on which an image has been formed, in an image forming apparatus, the method comprising:
forming an image on a printing medium;
detecting whether the after-treatment unit is in a possible state to perform the after-treatment on the printing medium when the printing medium is predetermined to be outputted from a main body of the apparatus to a after-treatment unit which performs a predetermined after-treatment on the printing medium; and
outputting selectively the printing medium to one of the after-treatment unit and at least one main body output tray, coupled to the main body, according to a detected result.

11. The method of claim 10, wherein the selectively outputting of the printing medium comprises:
outputting the printing medium to the after-treatment unit if the after-treatment unit is in the possible state, or to the main body output tray, if the after-treatment unit is not in the possible state.

12. The method of claim 10, wherein the detecting of whether or not the after-treatment unit is in the possible state comprises detecting whether a jam of the printing medium is generated in the after-treatment unit.

13. The method of claim 10, wherein the detecting of whether the after-treatment unit is in the possible state comprises displaying an error message reporting that the after-treatment unit is not in the possible state, if the after-treatment unit is not in the possible state.

14. The method of claim 13, wherein the selectively outputting of the printing medium comprises
outputting the printing medium to the main body output tray according to a first command, if the first command is inputted through the user input unit while the error message being displayed, the first command being preset to output the printing medium from the image forming apparatus.

15. The method of claim 13, wherein the selectively outputting of the printing medium comprises canceling the forming of an image according to a second command, if the second command is inputted through the user input unit while the error message being displayed, the second command being preset to cancel a formation of an image.

16. The method of claim 10, wherein the selectively outputting of the printing medium comprises
outputting the printing medium to the main body output tray according to a first command, if the first command is inputted through the user input unit, the first command being preset to output the printing medium from the image forming apparatus.

17. The method of claim 10, wherein the selectively outputting of the printing medium comprises canceling the forming of an image according to a second command, if the second command is inputted through the user input unit, the second command being preset to cancel a formation of an image.

18. The method of claim 10, wherein the after-treatment unit comprises at least one of a stapling module configured to staple the printing media, a punching module configured to punch holes on the printing media, a folding module configured to fold the printing media, or combinations thereof.

19. A method for an image forming apparatus, comprising:
forming an image on a printing medium;
detecting whether an after-treatment unit is in a functionally operable state; and
outputting the printing medium selectively to one of the after-treatment unit and another output printing medium destination responsive to the detecting.
